(19) United States
(12) Patent Application Publication
(10) Pub. No.: US 2022/0176637 A1
(43) Pub. Date: Jun. 9, 2022

(54) METHOD AND APPARATUS FOR THE SEQUENTIAL ADDITIVE MANUFACTURING OF CONTINUOUS MATERIAL TRANSITIONS IN COMPOSITE LAYERS

(71) Applicant: Massachusetts Institute of Technology, Cambridge, MA (US)

(72) Inventors: Nicolas A. LEE, Cambridge, MA (US); Ramon WEBER, Cambrige, MA (US); Joseph Henry KENNEDY, JR., Cambridge, MA (US); Joshua VAN ZAK, Cambridge, MA (US); Jorge DURO-ROYO, Cambridge, MA (US); Neri OXMAN, New York, NY (US)

(21) Appl. No.: 17/475,008

(22) Filed: Sep. 14, 2021

Related U.S. Application Data
(60) Provisional application No. 63/051,581, filed on Jul. 14, 2020.

(51) Int. Cl. B29C 64/393; B29C 64/118; B33Y 10/00; B33Y 30/00; B33Y 40/20; B33Y 50/02

(52) U.S. Cl. CPC B29C 64/393; B29C 64/118; B33Y 50/02; B33Y 30/00; B33Y 40/20; B33Y 10/00

(57) ABSTRACT

A fabrication method includes receiving information corresponding to a first pattern, receiving information corresponding to a second pattern, controlling an extruder to print a first semi-liquid material in the first pattern, and controlling the extruder to print a second semi-liquid material in the second pattern. The extruder controlling operations may be performed to combine the first semi-liquid material with the second semi-liquid material to form a composite having a third pattern. The third pattern may be, for example, a continuously graded three-dimensional multiple-material composite.

### CROSS-REFERENCE TO RELATED APPLICATION

This application claims benefit under 35 U.S.C. § 119 of provisional patent application No. 63/051,581, filed on Jul. 14, 2020, the contents of which is incorporated by reference herein in its entirety.

### FIELD

One or more embodiments described herein relate to manufacturing composites using extrusion techniques for semi-liquid materials, including but not limited to viscous materials.

### BACKGROUND

Viscous and other forms of semi-liquid materials are undeniably valuable yet particularly challenging when preparing surfaces requiring layers of these materials. Gels, for example, are materials that include a three-dimensional crosslinked polymer or colloidal network immersed in a fluid. They are usually soft and weak, but can be made hard and tough. Hydrogels are gels that have water as their main constituent. For example, a hydrogel is a substance formed when an organic polymer (natural or synthetic) is cross-linked via covalent, ionic, or hydrogen bonds to create a three-dimensional open-lattice structure which entraps water molecules to form a gel. Such a substance comes in a variety of forms and is highly versatile and thus suitable for use in many applications. Examples include the manufacture of contact lenses, hygiene products, wound dressings, drug delivery and tissue engineering, as well as various biomedical and other applications. In spite of their benefits, many hydrogel-based products and methods of manufacture have drawbacks that produce transitional imperfection, non-continuity or other inconsistencies. They also require the use of specialized equipment. As a result, hydrogel-based manufacturing has proven to be error-prone, as well as time-consuming, expensive, and complex to implement.

### SUMMARY

Embodiments described herein provide a system and method that controls additive manufacturing techniques to form a composite of different semi-liquid materials. The semi-liquid materials include, but are not limited to, various types of hydrogels, non-hydrogel semi-liquid materials, lipids, hydrophobic materials, hydrophilic materials and/or other types of gels, viscous materials, and semi-liquid materials that may be additively combined to form a structure that either corresponds to or is included in a final product.

The aforementioned or other embodiments may be performed without requiring the use of specialized or multiple forms of equipment, which may, in turn, significantly reduce manufacturing costs and complexity. For example, one or more embodiments may not require the use of multiple extruders for dispensing multiple hydrogels and/or other materials in forming a composite, nor do they require simultaneous extrusion from multiple chambers of semi-liquid materials in forming a composite.

The aforementioned or other embodiments may control the manufacturing of a composite product by 3D printing a plurality of materials (including hydrogels) in series. This may, in turn, diffuse transitions between the materials and remove or reduce discrete transition interfaces, at least to a degree which surpasses mechanical resolution. This may, in turn, increase the quality and durability of the final product.

The aforementioned or other embodiments may form transitions of different materials in the composite without performing dithering and using techniques that fully blend into continuous gradients or maintain discrete transitions (or transition interfaces) depending on the viscosity of the material(s), ambient conditions, and/or other considerations.

The aforementioned or other embodiments allow for fabrication of a composite at various length scales, including but not limited to those ranging from millimeters to meters.

In accordance with one or more embodiments, a fabrication method includes (a) receiving information corresponding to a first pattern, (b) receiving information corresponding to a second pattern, (c) controlling an extruder to print a first semi-liquid material in the first pattern, and (d) controlling the extruder to print a second semi-liquid material in the second pattern, wherein (c) and (d) are performed to combine the first semi-liquid material with the second semi-liquid material to form a composite having a third pattern.

In accordance with one or more embodiments, a control system for fabricating a composite of materials includes at least one processor and a non-transitory computer-readable medium storing instructions which, when executed by the at least one processor, causes the at least one processor to: (a) receive information corresponding to a first pattern; (b) receive information corresponding to a second pattern; (c) control an extruder to print a first semi-liquid material in the first pattern; and (d) control the extruder to print a second semi-liquid material in the second pattern, wherein (c) and (d) are performed to combine the first semi-liquid material with the second semi-liquid material to form a composite pattern.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a block diagram of an embodiment of a method for the sequential additive manufacturing of a composite which includes one or more semi-liquid materials, one non-limiting example of which is a functionally-graded composite.

FIG. 2A is a diagram showing perspective view of an embodiment of a system for performing sequential additive manufacturing of a multiple-material composite.

FIG. 2B is a diagram showing perspective view of an operation of depositing multiple materials as performed by the system of FIG. 2A.

FIG. 2C is a diagram showing perspective view showing an example of how one material may locally diffuse into another material deposited in FIG. 2B to form continuously graded material transitions.

FIG. 3 is a block diagram of an embodiment of a fabrication workflow for manufacturing a multiple-semi-liquid material composite with continuous gradation and no or a reduced number of transitional interfaces resulting, for example, from local diffusion.

FIG. 4 is a block diagram of an embodiment of a fabrication workflow for manufacturing a multiple-material composite with discrete transition interfaces.

FIG. 5A is a diagram showing a perspective view of an embodiment of a motion-controlled extrusion apparatus for the sequential additive manufacturing of a multiple-material composite.

FIG. 5B is a diagram showing a top or plan view of the apparatus of FIG. 5A.

FIG. 5C is a diagram showing a view of the apparatus of FIG. 5A from one side.

FIG. 5D is a diagram showing a view of the apparatus of FIG. 5A from another side.

FIG. 6 is a diagram showing a perspective view of examples of end effectors with interchangeable nozzles of variable diameters.

FIG. 7 is a block diagram showing an embodiment of a processing system which may be used to perform operations of the embodiments described herein.

The drawings are not necessarily to scale, or inclusive of all elements of a system, emphasis instead generally being placed upon illustrating the concepts, structures, and techniques sought to be protected herein.

### DETAILED DESCRIPTION

Embodiments described herein include systems and methods for performing additive manufacturing techniques to form a composite of multiple materials, which materials may include, but are not limited to, one or more hydrogels that are combined to form a composite that corresponds to or is included in a final product.

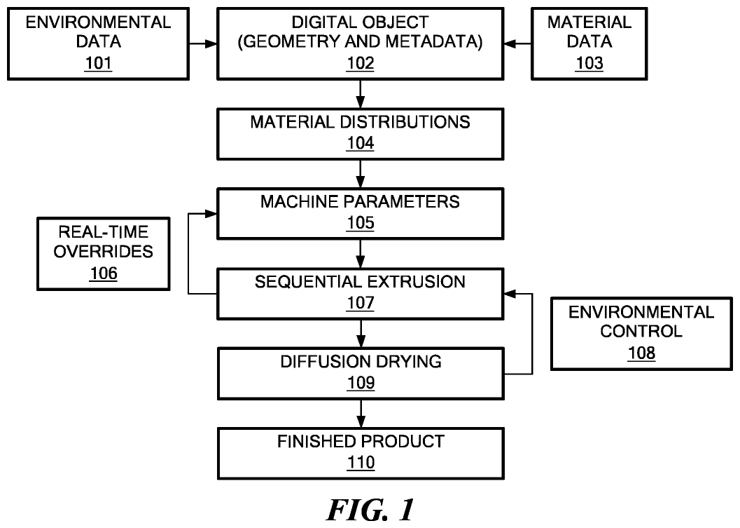

FIG. 1 is a block diagram showing operations included in an embodiment of a method for performing sequential additive manufacturing of a composite, which may include, for example, a plurality of semi-liquid materials, such as, e.g., various types of hydrogels, non-hydrogel semi-liquid materials, lipids, hydrophobic materials, hydrophilic materials and/or other types of gels, viscous materials, and semi-liquid materials. The composite may include a plurality of functionally-graded hydrogels, or one that is not functionally graded. Examples of the composite structure are discussed below. Although hydrogels are described in the following non-limiting examples, the instant invention is equally applicable to other semi-liquid materials or viscous materials as described herein.

Embodiments described herein may perform operations including translating digital design parameters to machine parameters, which may then be used to control the extrusion of multiple hydrogels to form the composite. In one implementation, the multiple hydrogels may be continuously graded and include transitional features (or interfaces). In other implementations, the hydrogels may diffuse into one another to reduce or eliminate the transitional interfaces, at least to a degree that surpass a mechanical resolution. Such a method may therefore be used to implement the digital fabrication of a multiple-hydrogel composite. An embodiment where the composite is formed by three-dimensional (3D) printing is discussed below.

Referring to FIG. 1, the method may include, at 101, receiving environmental data 101 from a host system or controller or a designer. The environmental data may be indicative of one or more ambient condition(s) that could impact material behavior. Examples of the ambient conditions include light, temperature and humidity, but other examples are possible as well.

At 102, the environmental data may be used as a basis to generate one or more digital objects, which may include various types of information in preparation for digital fabrication. This information may include, for example, geometry data and metadata corresponding to the various hydrogels and other materials of the composite (if any), as well as geometry data and metadata of the composite in its final form.

At 103, material data is received, for example, from the host system or designer. The material data may include information indicating the viscosity of one or more fabrication materials used for the composite or finished product, which materials may include one or more hydrogels. The material data may also provide an indication of the stiffness, strength, elasticity and/or one or more other features of the hydrogel(s). In addition to the environmental data, the material data may be used as a basis for generating digital object(s).

Returning to operation 102, in one embodiment the one or more digital objects may be formatted as one or more mesh objects in a computer-aided design (CAD) environment. The mesh object(s) may be encoded with positional (e.g., XYZ) data, geometry information and/or metadata provided in the form of an extra component per material per point, which describes the amount of material intended to be deposited at each position.

At 104, information from the digital objects may enter a material distribution stage as a series of XYZ points and 1×N normalized weight vectors, where N corresponds to the number of materials to be extruded. In operation 104, this information may be processed into N connected toolpaths formatted as a series of XYZ points, with each point containing a single component of a weight vector at that location.

At 105, machine parameters are generated (e.g., by a translator or controller) to connect the points identified in operation 104 to form a continuous path. During this process, lead-in and lead-out measures may be appended to enable initial and final positioning one or more machines that is/are to be used to manufacture the composite. In addition, weight vector components may be translated by the translator to a value in a predetermined range (e.g., from 0 to 1000) in order to control extrusion pressure.

In one example implementation, a feed rate value from 100 mm/s to 5000 mm/s may be appended to designate the velocity of a hydrogel extruder (e.g., in mm/min) at each point. Lead-in and lead-out points may receive no pressure and a maximum feed rate. This information may be output, for example, in the form of a series of G-code commands containing position, extrusion pressure, and feed rate. The use of G-code commands is just one example. A different type of commands may be used in another embodiment.

At 107, during a sequential extrusion operation, each toolpath may be sent through in series or according to a predetermined workflow. At 106, one or more real-time overrides may be performed to enable an adjustment of extrusion pressure and feed rate during extrusion of the hydrogels and, if any, additional non-hydrogel materials. The extrusion of the hydrogels may be performed sequentially or one or more intervening operations may be included between the extrusion operations of the hydrogels. In one embodiment, the duration between sequential extrusions can be increased or decreased to control diffusion of the hydrogels and the continuity of material gradations (e.g., transitional interfaces). When a sequential extrusion 107 of hydrogels is performed, a diffusion drying operation 109 may be performed to dry the hydrogels.

At 108, an environmental control operation may be performed. This operation may include, for example, the regulation of environmental temperature and humidity. In one non-limiting example decreasing temperature to within a range of 20° C.-25° C. and increasing humidity to within a range of 30%-70% may increase the continuity (or transitional interfaces) of gradients of different hydrogels being extruded in order to form the composite.

At 110, the finished composite product may represent the point at which materials have dried into one or more solid composites. The product may therefore be or include at least one composite of series-coupled hydrogels with continuously graded transitional zones produced using only a single extruder during a digital fabrication workflow. In one embodiment, a functionally-graded hydrogel composite may be formed using multi-material 3D printing of biopolymers. The resulting composite may itself be or may be used to form a structure on length scales ranging, for example, from millimeters to meters.

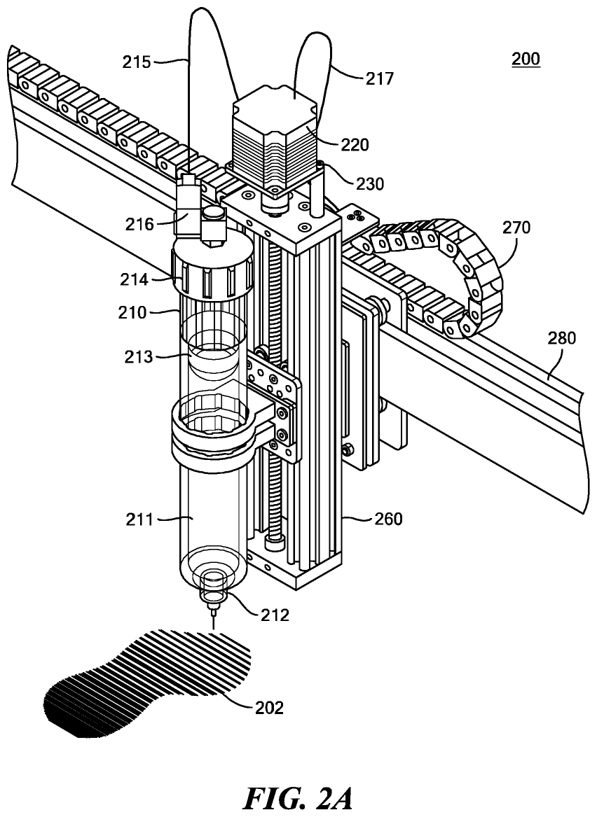

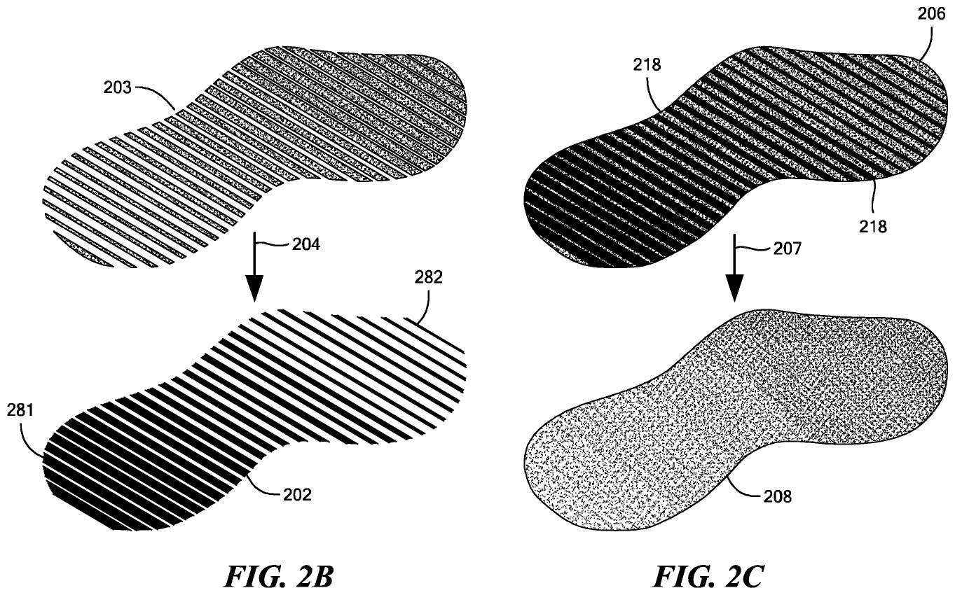

FIG. 2A shows an embodiment of an extrusion system 200 which may be used to perform the sequential additive manufacturing of a multiple-hydrogel composite, including but not limited to the functionally-graded hydrogel composite corresponding to the method of FIG. 1. The extrusion system may perform operations included in the method of FIG. 1 or may perform a variant of that method or even a different method, provided, for example, a functionally-graded hydrogel composite is formed with the properties described herein.

Referring to FIG. 2A, the extrusion system 200 includes a single extruder 210, a pressure source 220, and a controller 230. The extruder 210 includes a container 211, a nozzle 212, an actuator 213, and a cap 214. The container 211 holds up to a predetermined supply of material, which, for example, may be a hydrogel material. The nozzle 212 has an orifice for dispensing the material in the container onto an adjacent work surface. The actuator 213 applies pressure within the container to dispense the material through the nozzle. In one embodiment, the actuator may include a plunger or other moveable surface for generating the dispensing pressure.

The cap 214 secures the material within the container. In one embodiment, the cap may be removable from a top area of the container to allow it to be filled with material, e.g., hydrogel. Because the present embodiment is used to implement a method of dispensing different hydrogels sequentially on the work surface, the cap may be removed to fill the container to dispense a first hydrogel. Then, the cap may be removed one or more additional times to load the container with a respective number of additional hydrogels for dispensing to form the intended composite. In one embodiment, multiple hydrogels may be input into the container in a sequential pattern for dispensing, and thus for purposes of forming the composite.

The pressure source 220 may be, for example, a pneumatic pressure source which applies compressed air into the container and against the actuator 213. The air may be input into the container through a hose 215 and port 216 in the cap 214. In one embodiment, the compressed air may be received through a hose 217 and pressure-related by a pump coupled to controller 230. In this embodiment, controller 230 is shown as being included on the extruder system. In another embodiment, the controller may be located on at a remote location either within or connected to the system, either through a wired or wireless link. An inner surface of the cap may include a seal or gasket which prevents the pressurized air from escaping during a dispensing operation. The rate at which the air is injected into the container controls the amount of pressure applied against the actuator 213 and thus the rate and amount of hydrogel being dispensed on the work surface. In another embodiment, the pressure source or pump 220 may apply another form of pressure against the actuator, e.g., mechanical, hydraulic, etc.

The controller 230 controls the amount of pressure to be applied by the pressure source against the actuator, in order to control the rate and amount of hydrogel (or other material) to be dispensed in a predetermined pattern on the work surface. In one embodiment, the extruder 210, the pressure source 220, and/or the controller 230 may be supported by the frame of a housing 260. The housing may be, for example, moveable or stationary. In the latter case, the work surface may be controlled to move during a dispensing operation.

In the embodiment of FIG. 2A, the frame of the housing 260 is coupled to the chain 270 of a track 280 to move the housing in a first direction (e.g., laterally). The track may then be controlled to move in a second direction, which may be perpendicular to, but within the same plane as, the first direction. The controller 230 may control movement of the housing in the first and second directions or a different controller may perform this operation in synchronization with the dispensing control (e.g., rate and amount) by controller 230. In FIG. 2A, an example is shown where movement of the housing is controlled in the first and second directions to form a predetermined two-dimensional pattern of the dispensed hydrogel 202. In another embodiment, a different pattern may be formed, depending, for example, on the application and shape requirements of the composite. The extrusion system may also allow the nozzle and container to move vertically.

The controller 230 may include one or more circuits for controlling the aforementioned operations. The one or more circuits may be included in an integrated circuit chip which, in one implementation, may generate digital control information for managing the dispensing process. The digital control information may therefore numerically control the single extruder 210 and its associated features in dispensing multiple hydrogels sequentially to form the intended composite. For example, a first hydrogel may be input into the extruder and dispensed at a first rate and first amount in a first predetermined pattern. Then, a second hydrogel may be input into the extruder and dispensed at a second rate and second amount in a second predetermined pattern. The first and second patterns may be indicated, for example, by the geometry information encoded in the digital object(s) generated in operation 102 of FIG. 1. The first and second predetermined patterns may be the same or different. In one embodiment, the first and second patterns may be complementary patterns as described with respect to the example discussed below.

FIG. 2B shows an example of where the first hydrogel (or other material) 202 is dispensed in substantially parallel adjacent spaced lines to form the first predetermined pattern. In the example of FIG. 2B, the controller 230 controls dispensing of the first hydrogel with a graded pressure, so as to deposit more material at a first end of the pattern than the material deposited at another (or opposing) end of the pattern. The graded dispensing of material is shown by heavier lines 281, which steadily reduce in width until toward the second end, which show the lesser amount of material in by thinner lines 282. In this graded pattern, the spacing between the lines may change from the first end to the second end.

After the first hydrogel is deposited, the container may be loaded with another material (e.g., a second hydrogel) and the controller 230 may control dispensing of the second hydrogel 203 in a second predetermined pattern. In the example of FIG. 2B, the second hydrogel is dispensed, at 204, in a complementary pattern directly on top of the first hydrogel pattern 205 via a sequential additive manufacturing operation. The complementary pattern causes the second hydrogel to at least partially extend between the spaces between the lines of first hydrogel in the first pattern. In this embodiment, the widths of the lines of second hydrogel 203 increase as the width of the lines of the first hydrogel 202 decrease in a proportional amount. During this process the first and second hydrogels may or may not substantially overlap. In one embodiment, only two hydrogels may be used to form the composite. However, one or more additional dispensing operations may be performed with one or more corresponding hydrogels or other materials to form the composite in another embodiment.

Additionally, in some embodiments the first and second hydrogels may have different properties. For example, the first hydrogel may have a first viscosity and the second hydrogel may have a second viscosity different from the first viscosity. In other embodiments, the hydrogels may be different types of hydrogels. In other embodiments, the hydrogels may be made of particles with different sizes. In other embodiments, a combination of different features of the hydrogels may be present.

FIG. 2C shows an example of the combined form 206 of the first and second hydrogels while the hydrogels are still wet or at least in an at least partially liquid state. The pattern of combination 206 (e.g., third pattern) is substantially the same, in geometry, as the first and second patterns, e.g., immediately after the operation of applying the second (or last sequential hydrogel), both hydrogels substantially retain their initial toolpath geometry in discrete regions. In other embodiments, the geometrical pattern of combination 206 may be different from one or more of the first and second predetermined patterns.

At this point, the first and second hydrogels may be integrated with one another, either actively or passively, to form the composite to have a substantially continuous surface. Passive integration may be performed, for example, by waiting a duration of time to allow the hydrogels to mix with and diffuse into one another to form a continuous surface without or with reduced discrete transition interfaces between the hydrogels. Active integration may be performed, for example, by performing a drying operation while the first hydrogel and the second hydrogel. Each form of integration may provide better results than the other form of integration depending, for example, on the materials used. In other embodiments, the first and second hydrogels may be integrated with one another to form the composite to have a non-continuous and/or the various layers of the hydrogels may be disposed in an overlapping relationship or otherwise combined or deposited in predetermined patterns.

As indicated, in one embodiment, the extruded hydrogels may locally diffuse into and thus blend with one another to form a composite 208 with a substantially continuous or homogeneous surface. Such a continuous or homogeneous surface of composite excludes (or has a reduced number of) discrete transitional interfaces 218, such as those that appear in the composite 206 in its wet or at least partially liquid state. In one embodiment as described in the example above, the local diffusion of the hydrogels are allowed to dry 207 for a duration of time, thereby causing the composite 206 (in a wet or at least partially liquid state) to dry into a continuously graded composite 208 containing both materials (e.g., hydrogels).

As shown in FIG. 2C, through the system and method embodiments described herein, the composite 208 is smooth and continuous without transition interfaces 218 between the first and second hydrogels that are blended. This may substantially improve the quality of the composite, especially in cases where the optical properties of the composite are important. The system and method embodiments also produce a composite of superior quality compared with systems that use multiple extruders. In contrast, a multiple-extruder approach allows the transition interfaces (e.g., 218) between the different hydrogels to be clearly visible (or otherwise detectable), which, in turn, would produce a lower quality composite.

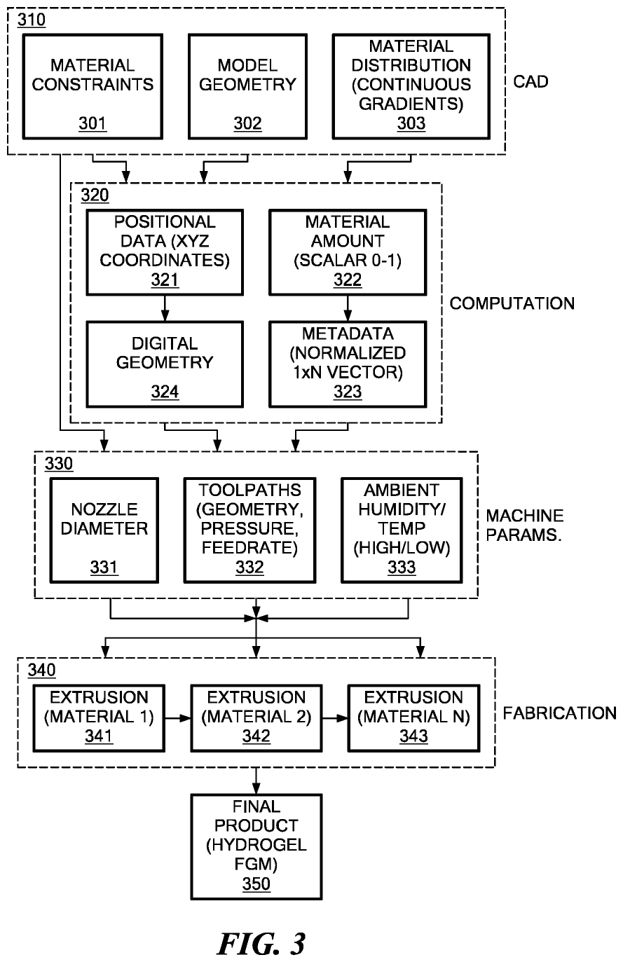

FIG. 3 is a block diagram of an embodiment of an integrated fabrication workflow for generating a multi-hydrogel composite with continuous gradation and no or fine transitional interfaces.

Referring to FIG. 3, the fabrication workflow includes a computer-aided design (CAD) stage 310, a computation stage 320, a machine parameters stage 330, and a fabrication stage 340. One or more of these stages may define features of the composite, generate instructions based on those features, and translate those features to machine parameters based on the instructions. The machine parameters may then be used to control the single extruder to sequentially deposit multiple hydrogels and/or other materials to form the intended composite. This workflow (or method) is integrated at least from the standpoint that it provides for seamless digital file-to-fabrication operations to be performed from the CAD software of a designer to automatic control of operation of the machine, e.g., single extruder and its associated features. In one embodiment, the CAD software may be used to generate a model of the composite, which may or may not include a model of each stage in the fabrication of the composite. After the fabrication workflow is completed, a multiple-hydrogel composite (which may or may not be functionally-graded) is formed for the intended application or incorporation with other features to form a finished product.

The CAD stage 310 may receive information from a system designer to generate a model of the various features of the composite to be fabricated. This information may indicate, for example, one or more of material constraints 301 of the composite (e.g., one or more hydrogels or other materials), the geometry 302 of the deposit pattern of each hydrogel (or other material) of the composite and geometry of composite in its final form, and a material distribution 303 with continuous gradients of the hydrogels (and/or other semi-liquid materials) in the final form of the composite. In one embodiment, the CAD stage 310 may include a user interface to allow, for example, input of the one or more of the material constraints 301, geometry 302, or material distribution 303. Additionally, or alternatively, all or some of this information may be automatically generated, for example, by a host program or system and input into the CAD stage 310.

In one embodiment, the model may represent the composite as at least one mesh object, with vertices containing color data that encodes the material distributions at each point. The mesh object may further include information indicative of physical properties of the extruded material (e.g., hydrogel(s)) such as viscosity and particle size, which in some embodiments may be referred to as material constraints in FIG. 3. The geometry of the composite model and its material constraints may be used by the controller to translate positional data to a digital geometry during the computation (instruction generation) stage 320. In one embodiment, the digital geometry may include an indication of an infill toolpath traveled by the extruder in order to additively construct the designed geometry.

The computation stage 320 may translate information output from the CAD stage 310 into various data, including positional data 321 and material amount data 322. For example, during instruction generation, the system controller of the computation stage may translate the material distribution data 303 of the virtual model generated by the CAD stage into the material amount data 322, which includes one or more scalar values per material, per vertex. All scalar values per point may be added to a 1×N material weight vector, where N is the total number of materials to be extruded, and normalized to form a metadata vector 323 that encodes the amount of material (e.g., hydrogel) to be deposited at each point per material.

In addition, the system controller of the computation stage may generate the positional data 321 from the material constraints 301 and model geometry 302 information received from the CAD stage. The positional data may include, for example, coordinates in a predetermined coordinate system (e.g., XYZ) that correspond to different points of the modeled composite and/or the patterns of one or more materials (e.g., hydrogels) of the composite. The series of XYZ positions indicated in positional data 321 may then be used as a basis of generating corresponding positions in a toolpath during fabrication, with each position containing a 1×N normalized material weight vector. The positional data may be used to form a digital geometry 324 of the composite and/or any of its individual features.

The machine parameters stage 330 may generate information indicative digital controls for the extrusion system, as well as indicate one or more predetermined physical parameters which, for example, in some embodiments may not be limited to nozzle diameter 331, e.g., may include additional parameters. In one embodiment, the digital geometry information (in the form of linked XYZ point series) and metadata (indicating the amount of material to be extruded at each point) are passed from the instruction generator of the computation stage to the machine parameters stage in the format of G-code and machine parameters for an extrusion apparatus.

In addition, the material constraints information 301 corresponding to the virtual model generated in the CAD stage 310 may be used by the machine parameters stage to determine nozzle diameter 331 for each deposition to be performed by the extrusion system and corresponding toolpaths 332 including geometry, pressure, and feed rate (e.g., the velocity at which the extrusion system moves to generate the various hydrogel patterns and the pattern of the composite).

In addition, the system controller of the machine parameters stage may designate and/or control of one or more environmental conditions that affect the extrusion process. The environmental conditions may include, for example, ambient humidity and/or temperature. In the workflow for used for fabrication of the multiple-hydrogel composite (e.g., functionally graded), humidity may be kept at high (e.g., a predetermined humidity above a threshold value), while temperature may remain low (e.g., a predetermined temperature below a threshold value) in order to prolong the drying process for an intended duration. The environmental conditions may help to produce what is effectively a composite with a continuous consistency without transition interfaces between the hydrogels (or other materials) deposited by the single extrusion system.

The G-code specifying positional data, feed rate, and extrusion pressure may be passed from the machine parameters stage to the system controller. The system controller may then regulate the pressure and motor position in order to control the extrusion process. The full set of commands related to the extrusion of all toolpaths for a single material may be referred to as a print sequence, as the fabrication method may be considered to be a 2D or 3D printing process in accordance with some embodiments. The machine parameters stage 330 may output one print sequence per hydrogel or other material of the composite.

The fabrication stage 340 may indicate print sequences of the hydrogels. In a three-material deposition process, for example, the fabrication stage may indicate that a first extrusion process 341 may be used to deposit a hydrogel or material, a second extrusion process 342 may be used to deposit a different hydrogel or material, and a third extrusion process 343 may be used to deposit a different hydrogel or material. Through this sequence of extrusion processes, materials are added one-by-one in the patterns and other information indicated in previous stages to generate a single composite. All three extrusion processes may be performed based on the nozzle diameter, toolpaths, and environmental conditions indicated for each deposition output from the machine parameters stage. The machine parameter information may be different from deposition to deposition, or one or more of the parameters may be the same for two or more of the depositions.

In one embodiment, the extrusion process may involve extruding different hydrogels, in which one or more solvents are able to locally diffuse. The amount of local diffusion may correspond, for example, to the amount of time for the hydrogels to fully evaporate into the dried composite, as shown in stage 350. In one embodiment, the dried composite may be a functionally- graded composite with fine transitional features. The drying period may be prolonged to maximize local diffusion.

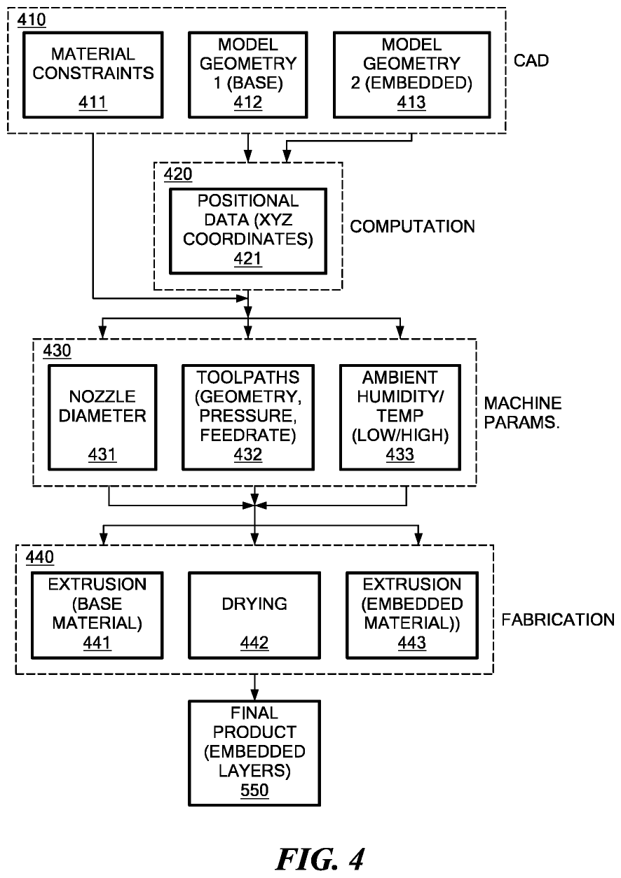

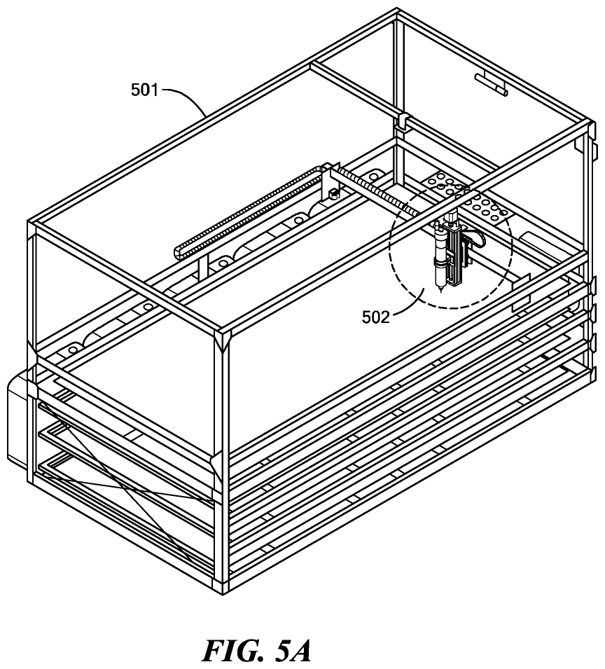

FIG. 4 is a block diagram of another embodiment of an integrated fabrication workflow for generating a multi-hydrogel composite. In this embodiment, location diffusion may be reduced or minimized and material transitions may be discrete and high-resolution and may maintain a printed geometry with high fidelity.

Referring to FIG. 4, this workflow is performed in a CAD stage 410, a computation stage 420, a machine parameters stage 430, and a fabrication stage 440. The CAD stage 410 may receive information, for example, from a system designer to generate a digital model including or based on material constraints 411, a first (base) geometry 412 of the composite being modeled (and its various features), and a second (embedded) geometry 413 with unique material qualities. The material constraints may indicate, for example, the viscosity and/or other properties of each material (e.g., hydrogel and/or other material) to be extruded. The digital geometries can be encoded, for example, as mesh objects or linear geometries.

The computation stage 420 may translate the base and embedded geometries 412 and 413 to positional data 421, which, for example, may include information indicating interconnected XYZ locations to be traveled by the extrusion system. The information indicating the base geometries and embedded geometries may be compiled separately and may receive unique toolpaths. The material constraints 411 may, for example, inform the geometry of these toolpaths including their resolution, the spacing of features in corresponding ones of the deposition patterns or in the composite, and/or one or more assumed width(s) of linear geometries.

The machine parameters stage 430 may process the positional data 421 and encoded material constraints by translating them into or otherwise generating a set of machine parameters. The machine parameters may include, for example, nozzle diameter 431 to be used for each deposition and corresponding toolpaths (e.g., geometry, pressure feed rate, etc.) and environmental conditions (e.g., ambient humidity and temperature). The translation performed in the machine parameters stage may include, for example, generating G-code commands for the nozzle diameter, toolpaths including XYZ locations, and/or environmental conditions. In contrast to the machine parameters stage 330, in this embodiment pressure may not vary within toolpaths. Nozzle diameter in 431 may be determined by material viscosity and the desired width of the linear geometries determined in CAD stage 410. Ambient humidity may be reduced or minimized (to one or more predetermined levels), while temperature is increased or maximized (to one or more predetermined levels), in order to accelerate increases in viscosity and reduce local diffusion.

The fabrication stage 440 indicates a sequence of processes to be performed in generating the composite. According to one example, the processes may include a first extrusion process 441 for the base material (hydrogel or other material), a drying process 442 for drying the base material, and a second extrusion process 443 for the embedded material (different hydrogel or other material). These processes may be performed by the extrusion system based on the machine parameters generated in stage 430. In this regard the extrusion processes 441 and 443 may be considered to correspond to a print sequence for the base and embedded materials.

The drying process 422 may include a period of evaporation allotted between the extrusion process for the base material and the extrusion process for the embedded material, in order to reduce or minimize local diffusion and preserve the features of the embedded material. In one embodiment, the evaporation period may not be extended to allow the base material (hydrogel) to fully dry, while at the same time may be implemented to prevent the embedded material (hydrogel) from being contained within the base material, thereby preserving formation of one or more discrete transitional interfaces between the different hydrogels to meet the design requirements of the composite and its intended application. In one embodiment, the hydrogel composite may include at least one composite material with high-fidelity geometric features of a secondary material. The final composite 550 may thus include one or more embedded layers.

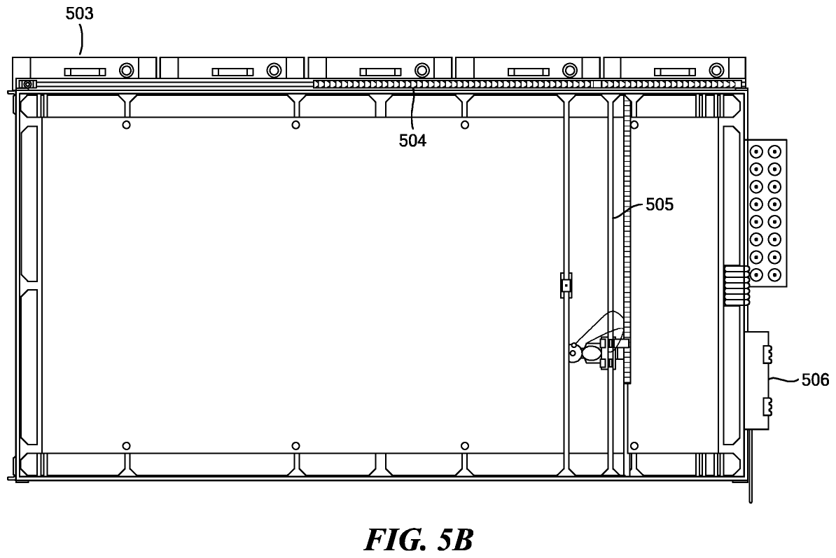

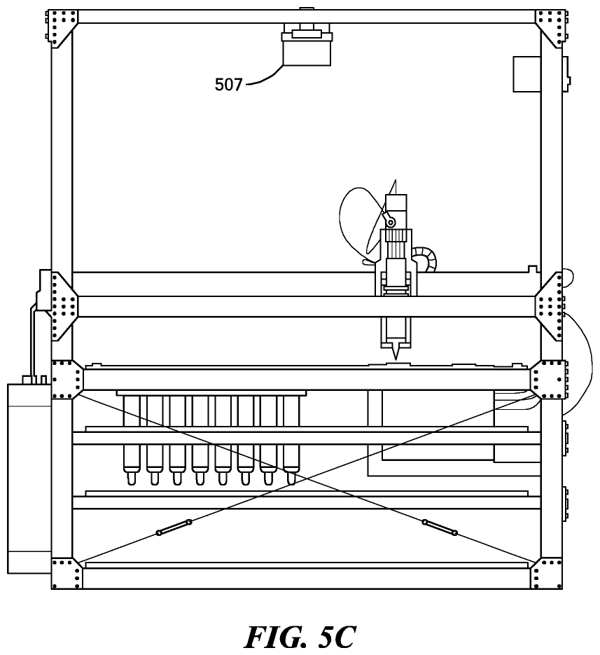

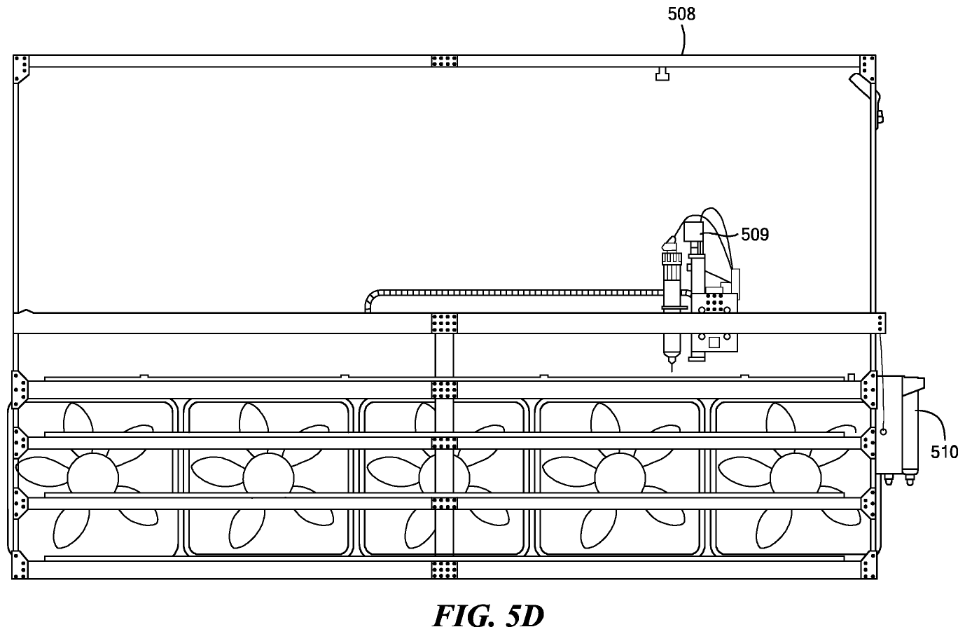

FIGS. 5A to 5D show an example embodiment of a motion-controlled extrusion apparatus for executing the sequential additive manufacturing methods described herein. FIG. 5A shows a perspective view of the apparatus. FIG. 5B shows a top or plan view of the apparatus. FIG. 5C shows a view from one side of the apparatus. FIG. 5D shows a view from another side of the apparatus. In operation, the apparatus may receive machine control information (e.g., location, extrusion pressure, feed rate, and/or other control information) and interprets variable inputs at a predetermined resolution, e.g., of up to 0.1 mm.

Referring to FIG. 5A, the apparatus includes a rigid aluminum scaffolding 501 that supports a single-nozzle extrusion system 502 affixed to a linear actuator with vertical travel capabilities, as well as movement in the first and second directions as previously described. The scaffolding 501 may also allow for the mounting of cameras and/or other sensor systems, and is sufficiently rigid in order to reduce or minimize vibration or other spurious forces that may cause inaccuracies during extrusion.

Referring to FIG. 5B, the extrusion apparatus may also include or be proximate or coupled to a series of box fans 503 arranged at one or more predetermined locations. The box fans may serve as dryers that are simultaneously or selectively controlled to perform evaporative drying via airflow. The apparatus may also include a linear rail 504 that houses a pressure line and wiring for stepper-motors (e.g., five motors) that enable X, Y, and Z axis travel of the extruder. In one embodiment, the linear rail 505 may provide Y-axis travel via a single stepper-motor affixed to the rail. The apparatus may also include a housing 506 to encase a control system (e.g., any of the controllers or processing systems mentioned herein) that interprets the machine commands (e.g., the G-Code previously discussed) in order to control position, feed rate, and pressure.

Referring to FIG. 5C, the apparatus may also include a lighting and camera module 507 for sensing and monitoring the printing process, including any errors or malfunctions that may occur during the deposition or other operations described herein.

Referring to FIG. 5D, the apparatus may also include a depth-of-field sensor 508 for monitoring deposition rate. Item 509 indicates Z-axis travel through motorized control (e.g., one or more stepper motors) of a linear actuator to which the extruder is affixed. Additional cartridges may be included in a housing 510 for performing the multi-material prints. The apparatus embodiment shown in FIGS. 5A to 5D is an example, and may have a different configuration with different features in another embodiment.

In one embodiment, the single-nozzle extrusion system 502 may be affixed to any 3-, 4-, or 5-axis motion controller including industrial robots or CNC systems of various scales, in order to execute the operations of the described method embodiments. In one embodiment, drying fans 503 may be replaced with systems that directly regulate drying time, for example, through modulation of ambient temperature and/or humidity.

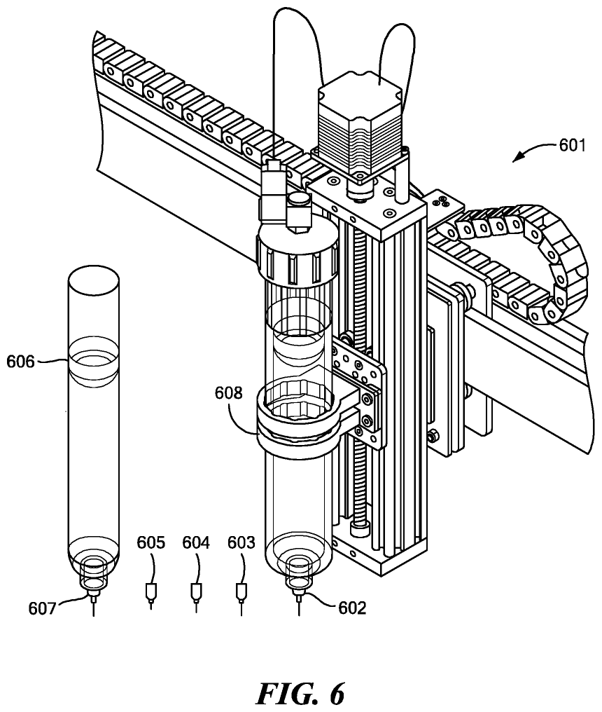

FIG. 6 is a perspective diagram showing an embodiment of an extrusion system 601 which may use end effectors having interchangeable nozzles of different diameters. Extrusion system 601 may be actuated by one or more electric motors. For example, stepper motors 509 may enable linear actuation or travel on linear rail 505 through a belt-driven connection.

Referring to FIG. 6, various nozzles 602 to 605 with different diameters and/or other properties may be removably attached to the cartridge (or container) 610 of the extruder. The removable nozzles may be, for example, fully conical or partially linear and may be made of metal or plastic components of a variety of gauges and lengths. For example, nozzle 603 may be a 20 Ga at 0.58 mm length (low viscosity hydrogels). Nozzle 604 may be 16 Ga at 0.52 mm length (medium viscosity hydrogels) or 14 Ga at 0.46 mm length (high viscosity hydrogels).

Removable barrel inserts 607 may be used to connect interchangeable nozzles to a 350 ml cartridge. Pneumatic extrusion may be driven by compressed airflow with pressure regulated by the control system in housing 506 to drive an inserted plunger 606 to extrude material loaded into the removable cartridge housed in holster 608. In addition to the example nozzles 602 to 605, a wide variety of other nozzles may be employed with geometries different than the ones shown in FIG. 6 and/or ones made of different materials such as high-strength plastic, stainless steel or glass and manufactured through different methods such as injection molding, casting or 3D printing.

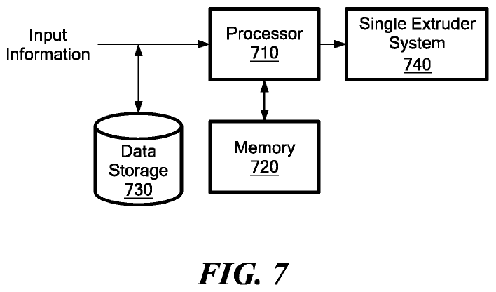

FIG. 7 is a block diagram showing an embodiment of a processing system that may be used to control the operations of the system and method embodiments described herein. The processing system includes a processor 710, a memory 720, and a data storage 730. The processor 710 may correspond to any of the controllers or other processing or logic features described herein, from performing operations in the digital fabrication workflow to controlling the movement and extrusion processes of the extrusion system and its associated pre- and post-processing. The processor 710 may operate based on instructions stored in the memory 720 and input information from a designer and/or automatically created during the workflow process. The input information may be stored in the data storage 730 (e.g., a database), along with other information relating to the composite features and extrusion process. The output of the processor 710 may include instructions and commands for controlling the single extrusion system 740 as described herein.

The aforementioned embodiments may controlling the 3D printing of multi-material hydrogels with high-resolution transitions between any number of materials using only a single pneumatic extruder that can be adapted to any generic positioning system, such as, but not limited to, a CNC gantry or industrial robot. These embodiments embody enabling technology and integrated workflow for the definition of machine parameters in an integrated motion and extrusion apparatus, allowing for the fabrication of both continuously graded hydrogels with features that surpass their mechanical resolution and discrete embedded material transitions (or transitional interfaces).

In one exemplary application of the system, an industrial robot or CNC gantry may be controlled to position the pneumatic extruder to deposit a numerically controlled volume of each of the hydrogels (and/or other materials) do be deposited. In one embodiment, a digital representation (or virtual model) of the composite object may be generated, along with machine parameters for control processing and post-processing operations, including those for controlling the single extruder. Through these disclosed embodiments, a system and method are provided for performing additive manufacturing of hydrogel composites with any number of materials, while retaining precise control over the spatial distribution of each material.

In addition to the aforementioned features, one or more embodiments described herein may allow for the formation of a multi-material (multi-hydrogel) composite having a gradation at a finer resolution than afforded strictly by systems that use a mechanical motor to perform material deposition. In some embodiments, the method may allow for continuous gradation between materials with substantial differences in viscosity, e.g., in some cases up to 20,000 cP. The embodiments may also allow for any number of materials to be compounded and additively manufactured in series.

From a software standpoint, one or more of the embodiments may provides a fully integrated workflow from a designed computer-representation or model of the composite (and each of its embedded layers or materials) and a material distribution to material-specific machine parameters. In one embodiment, the system and method may provide a virtual model with embedded data corresponding to a distribution of material properties. The system and method embodiments may also allow a user to construct functionally-graded systems from a mesh object and a single variable corresponding to material distributions.

Additionally, the embodiments described herein may operate flexibly across various scales and applications. The embodiments may also be extensible to a range of materials and geometric distributions, and may allow for customization of fabrication parameters, such as, but not limited to, nozzle diameter and ambient heat and humidity. The embodiments may also be extensible to various numerically controlled motion systems operating in synchronization with the extrusion system.

As used herein, the terms “processor” and “controller” are used to describe electronic circuitry that performs a function, an operation, or a sequence of operations. The function, operation, or sequence of operations can be hard coded into the electronic circuit or soft coded by way of instructions held in a memory device. The function, operation, or sequence of operations can be performed using digital values or using analog signals. In some embodiments, the processor or controller can be embodied in an application specific integrated circuit (ASIC), which can be an analog ASIC or a digital ASIC, in a microprocessor with associated program memory and/or in a discrete electronic circuit, which can be analog or digital. A processor or controller can contain internal processors or modules that perform portions of the function, operation, or sequence of operations. Similarly, a module can contain internal processors or internal modules that perform portions of the function, operation, or sequence of operations of the module.

As used herein, the term “predetermined,” when referring to a value or signal, is used to refer to a value or signal that is set, or fixed, in the factory at the time of manufacture, or by external means, e.g., programming, thereafter. As used herein, the term “determined,” when referring to a value or signal, is used to refer to a value or signal that is identified by a circuit during operation, after manufacture.

While electronic circuits shown in figures herein may be shown in the form of analog blocks or digital blocks, it will be understood that the analog blocks can be replaced by digital blocks that perform the same or similar functions and the digital blocks can be replaced by analog blocks that perform the same or similar functions. Analog-to-digital or digital-to-analog conversions may not be explicitly shown in the figures but should be understood.

The subject matter described herein can be implemented in digital electronic circuitry, or in computer software, firmware, or hardware, including the structural means disclosed herein and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this disclosure, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and memory can be supplemented by, or incorporated in, special purpose logic circuitry.

Various embodiments of the concepts systems and techniques are described herein with reference to the related drawings. Alternative embodiments can be devised without departing from the scope of the described concepts. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to element or structure A over element or structure B include situations in which one or more intermediate elements or structures (e.g., element C) is between elements A and B regardless of whether the characteristics and functionalities of elements A and/or B are substantially changed by the intermediate element(s).

Furthermore, it should be appreciated that relative, directional or reference terms (e.g. such as “above,” “below,” “left,” “right,” “top,” “bottom,” “vertical,” “horizontal,” “front,” “back,” “rearward,” “forward,” etc.) and derivatives thereof are used only to promote clarity in the description of the figures. Such terms are not intended as, and should not be construed as, limiting. Such terms may simply be used to facilitate discussion of the drawings and may be used, where applicable, to promote clarity of description when dealing with relative relationships, particularly with respect to the illustrated embodiments. Such terms are not, however, intended to imply absolute relationships, positions, and/or orientations. For example, with respect to an object or structure, an “upper” or “top” surface can become a “lower” or “bottom” surface simply by turning the object over. Nevertheless, it is still the same surface and the object remains the same. Also, as used herein, “and/or” means “and” or “or,” as well as “and” and “or.” Moreover, all patent and non- patent literature cited herein is hereby incorporated by references in their entirety.

The terms “disposed over,” “overlying,” “atop,” “on top,” “positioned on” or “positioned atop” mean that a first element, such as a first structure, is present on a second element, such as a second structure, where intervening elements or structures (such as an interface structure) may or may not be present between the first element and the second element. The term “direct contact” means that a first element, such as a first structure, and a second element, such as a second structure, are connected without any intermediary elements or structures between the interface of the two elements. The term “connection” can include an indirect connection and a direct connection.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the subject matter. All publications and references cited herein are expressly incorporated herein by reference in their entirety.

We claim:

1. An additive fabrication method to form a composite pattern, comprising:
(a) receiving information corresponding to a first pattern;
(b) receiving information corresponding to a second pattern;
(c) controlling an extruder to print a first semi-liquid material in the first pattern; and
(d) controlling the extruder to print a second semi-liquid material in the second pattern,
wherein (c) and (d) are performed to combine the first semi-liquid material with the second semi-liquid material to form the composite having a third pattern.

2. The method of claim 1, further comprising:
performing an operation to diffuse the first semi-liquid material into the second semi-liquid material to form the composite to have a substantially continuous surface.

3. The method of claim 2, wherein the substantially continuous surface excludes a transitional interface between the first semi-liquid material and the second semi-liquid material.

4. The method of claim 2, wherein the diffusing operation includes drying the first semi-liquid material and the second semi-liquid material while the first semi-liquid material and the second semi-liquid material are in an at least partially liquid state.

5. The method of claim 2, wherein the diffusing operation includes waiting a duration of time during which the first semi-liquid material dries in combination with the second semi-liquid material.

6. The method of claim 1, further comprising:
performing an operation to dry the first semi-liquid material before operation (d),
wherein the composite includes at least one discrete transitional interface between the first semi-liquid material and the second semi-liquid material.

7. The method of claim 1, wherein:
the first pattern includes a first graded pattern,
the second pattern includes a second graded pattern, and
the first gradation pattern is complementary to the second gradation pattern.

8. The method of claim 1, wherein the first pattern, the second pattern, and the third pattern have a same geometry.

9. The method of claim 1, wherein:
the first semi-liquid material has a first viscosity,
the second semi-liquid material has a second viscosity, and
the first viscosity is different from the second viscosity.

10. The method of claim 1, further comprising:
generating a model of the composite based on the information corresponding to the first pattern and the information corresponding to the second pattern;
generating geometrical and material information based on the model;
translating the geometrical and material information into machine parameters; and
performing (c) and (d) based on the machine parameters.

11. A control system for generating a composite pattern, comprising:
at least one processor; and
a non-transitory computer-readable medium storing instructions which, when executed by the at least one processor, causes the at least one processor to:
(a) receive information corresponding to a first pattern;
(b) receive information corresponding to a second pattern;
(c) control an extruder to print a first semi-liquid material in the first pattern; and
(d) control the extruder to print a second semi-liquid material in the second pattern,
wherein (c) and (d) are performed to combine the first semi-liquid material with the second semi-liquid material to form a composite having a third pattern.

12. The control system of claim 11, wherein, when executed by the at least one processor, the instructions cause the at least one processor to:
perform an operation to diffuse the first semi-liquid material into the second semi-liquid material to form the composite to have a substantially continuous surface.

13. The control system of claim 12, wherein the substantially continuous surface excludes a transitional interface between the first semi-liquid material and the second semi-liquid material.

14. The control system of claim 12, wherein the diffusing operation includes drying the first semi-liquid material and the second semi-liquid material while the first semi-liquid material and the second semi-liquid material are at least partially in a liquid state.

15. The control system of claim 12, wherein the diffusing operation includes waiting a duration of time during which the first semi-liquid material dries in combination with the second semi-liquid material.

16. The control system of claim 11, wherein, when executed by the at least one processor, the instructions cause the at least one processor to:
perform an operation to dry the first hydrogel before operation (d),
wherein the composite includes at least one transitional interface between the first semi-liquid material and the second semi-liquid material.

17. The control system of claim 11, wherein:
the first pattern includes a first graded pattern,
the second pattern includes a second graded pattern, and
the first gradation pattern is complementary to the second gradation pattern.

18. The control system of claim 11, wherein the third pattern is a continuous gradation pattern.

19. The control system of claim 11, wherein:
the first semi-liquid material has a first viscosity,
the second semi-liquid material has a second viscosity, and
the first viscosity is different from the second viscosity.

20. The control system of claim 11, wherein, when executed by the at least one processor, the instructions cause the at least one processor to:
generate a model of the composite based on the information corresponding to the first pattern and the information corresponding to the second pattern;
generate geometrical and material information based on the model;
translate the geometrical and material information into machine parameters; and
perform (c) and (d) based on the machine parameters.

21. The method of any of claims 1-10, wherein one or both of the first or second materials is a hydrogel.

22. The control system of any of claims 11-20, wherein one or both of the first or second materials is a hydrogel.
